(19) United States
(12) Patent Application Publication
(10) Pub. No.: US 2008/0288345 A1
(43) Pub. Date: Nov. 20, 2008

(54) COMPUTER-IMPLEMENTED SYSTEM AND METHOD FOR MARKETING PRODUCTS AND SERVICES

(76) Inventor: Alan Hirsch, Los Angeles, CA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/749,920

(22) Filed: May 17, 2007

(51) Int. Cl. G06Q 30/00; A63F 9/24

(52) U.S. Cl. 705/14; 463/9

(57) ABSTRACT

A computer-implemented system and method for advertising a product, brand or service without initially providing the name of the product, brand or service includes a computer hosting a website with a game that is accessible by a user device. The website provides a video of the product, brand or service to be advertised and prompts the user to enter a sweepstakes for a prize by submitting a guess as to the name of the product or service. The website can provide plurality of videos from which the user can select to view. The computer can be configured to send an email to the user when a subsequent video including the name of the brand is available to be viewed and to notify the user if he won the prize after the user views the subsequent video.

### FIELD OF THE INVENTION

The present invention relates generally to the field of marketing and advertising, and particularly to a computer-implemented system and method for marketing products and services.

### BACKGROUND OF THE INVENTION

Over the years, it has become increasingly more difficult to find a unique and effective marketing or advertising plan for promoting a brand. Conventionally, companies would provide commercials to be aired during television programs. However, as DVRs and PVRs (digital and personal video recorders) have become increasingly more popular, more and more viewers are recording television programs and skipping past the commercials.

Some have attempted to market their goods and services via the Internet. However, marketing via the Internet has its own challenges. For example, some companies have attempted to provide pop-up windows containing advertising videos, but many users of the Internet simply close the pop-up windows. Others have tried to purchase banners on popular websites, such as websites for search engines and the news. However, many users ignore such banners.

Accordingly, it can be seen that a need exists for a better way to advertise or market products and services. In particular, there are needs for improved on-line marketing systems that entice consumers to view such marketing and advertising materials. It is to such solutions that the present invention is primarily directed.

### SUMMARY OF THE INVENTION

Advantageously, the present invention provides a computer-implemented game for marketing products and services. By playing the game, contestants have the opportunity to win one of a number of prizes. To play the game, a contestant accesses a website, which hosts the game, and selects one of a plurality of videos to watch. Each video advertises a specific product or service, but the identity or brand of the product or service is withheld. After viewing the video, the user then submits a guess as to the identity or brand featured in the video. If the contestant is correct, the contestant is entered into a drawing to win a prize.

In one aspect, the present invention provides a computer-implemented game for marketing a product or service without providing an associated brand name. The game includes a computer hosting a website that is accessible by a network-connected user device. The website provides a video of the product or service to be marketed and prompts the user to enter a sweepstakes for a prize by submitting an entry, such as a guess or a vote, as to the brand name of the product or service. Preferably, the website provides a plurality of videos, wherein each video advertises a particular product or service, from which the user can select to view. The network-connected user device can include a computer, cellular phone, or personal digital assistant. The computer hosting the website can be configured to send an email to the user when a subsequent video including the brand name is available to be viewed. The computer can also be configured to notify the user if he won the prize after the user views the subsequent video.

In another aspect, the present invention provides a method of advertising an item or service. The method includes the steps of displaying a video commercial to a participant, wherein the video does not include a name of the item or service that is being advertised; prompting the participant to submit an entry including a guess as to the name of the item or service; and if the participant provides a correct name, then entering the participant in a drawing for a prize. The displaying of the video commercial can be made by streaming the video commercial via an Internet website. Preferably, the method includes the further steps of receiving from the participant a selection of one of a plurality of video commercials to be displayed, displaying the correct name to the participant after the participant provides the guess, and randomly selecting an entry from the correct guesses as the winning entry. More preferably, the correct name is displayed to the participant after the drawing. Displaying the correct name can further include playing a subsequent video commercial including the brand name. Additionally, the system can prompt a marketer or advertiser to upload a video of a product or service to be advertised.

In another aspect, the present invention provides a system for marketing a branded product or service. The system includes a plurality of network devices and a server connected to a communications network. The server hosts a website that is accessible by the plurality of network-connected user devices and that provides a game for guessing the brand being marketed. The system receives a request from the participant via the website for initiating the game, displays a selected video via the website, and receives a user input including a guess as to an identity of the brand. The system can further be configured to receive a selection of one video from a plurality of videos to be displayed, to display the brand being marketed after receiving the user input, and to communicate with the winning user.

These and other features and advantages of the present invention will become more apparent upon reading the following specification in conjunction with the accompanying drawing figures.

### BRIEF DESCRIPTION OF THE DRAWINGS

FIG. 1 is a functional block diagram illustrating a system architecture for marketing a brand via a game on a website according to an example embodiment of the present invention.

FIG. 2 is a screenshot of the website of FIG. 1 according to an example embodiment of the present invention.

FIG. 3 is a flow diagram of a process by which the system of FIG. 1 provides the game.

FIG. 4 is a screenshot of another page of the website of FIG. 2 according to an example embodiment of the present invention.

FIG. 5 is a flow diagram of a process for providing the correct name of the brand being marketed by the system of FIG. 1.

FIG. 6 is a flow diagram of a process by which the system of FIG. 1 solicits and receives videos.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

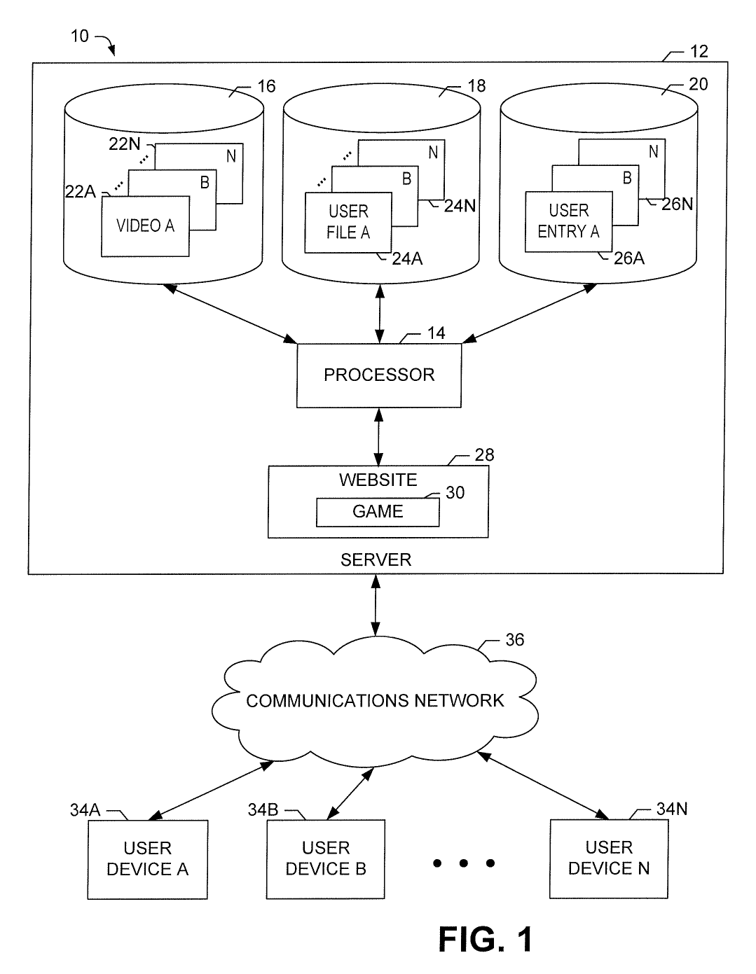

Referring to the drawings figures, FIG. 1 is a functional block diagram illustrating the system architecture of a system 10 for marketing or advertising a product or service according to an example embodiment of the present invention. The system 10 includes a server 12 with a computer processor 14 and at least one computer-readable storage medium, and preferably three storage media 16, 18, and 20. The computer-readable storage media 16, 18, and 20 each can be any suitable information storage unit, such as any suitable magnetic storage or optical storage device, including magnetic disk drives, magnetic disks, optical drives, optical disks, and memory devices, including random access memory (RAM) devices, and flash memory. The first storage medium 16 stores a plurality of videos 22A-N. The videos 22A-N can be commercials or other short videos that each advertise a particular brand of a product or service. Preferably, each video 22 has a duration of about ten seconds to about five minutes. More preferably, each video 22 has a duration of about twenty seconds to about three minutes. Even more preferably, each video 22 has a duration of about twenty seconds to about fifty seconds. However, those skilled in the art will understand that videos having a duration shorter than about ten seconds and longer than about five minutes are within the scope of the present invention. Preferably, the name of the brand is not revealed during playing of the video 22. The videos 22A-N can be stored in any suitable format, including, but not limited to .mpeg, .wmv, .swf, .mov, and any combination thereof. Optionally, the website 28 can include one or more vignettes, short videos, or trailer videos, that provides a notice of an upcoming video (e.g., a short video similar to a movie preview). In such instances, the user cannot yet guess or vote on the name of the brand. Rather, the website 28 can list the date when the “full” video will be available, which is when the game will begin.

The second storage medium 18 stores files 24A-N of registered users of the system 10. The registered user files 24A-N can include the registered users' contact information and login information (such as username and password) for each user who uses the system 10. The third storage medium 20 stores entries 26A-N for each sweepstakes drawing. Additionally, there can be more than one storage medium 20, so that each storage media 20 would include entries associated with a particular video 22 and sweepstakes drawing. Alternatively, the videos 22A-N, the registered user files 24A-N, and the entries 26A-N can be stored together on a single storage medium or on multiple storage media.

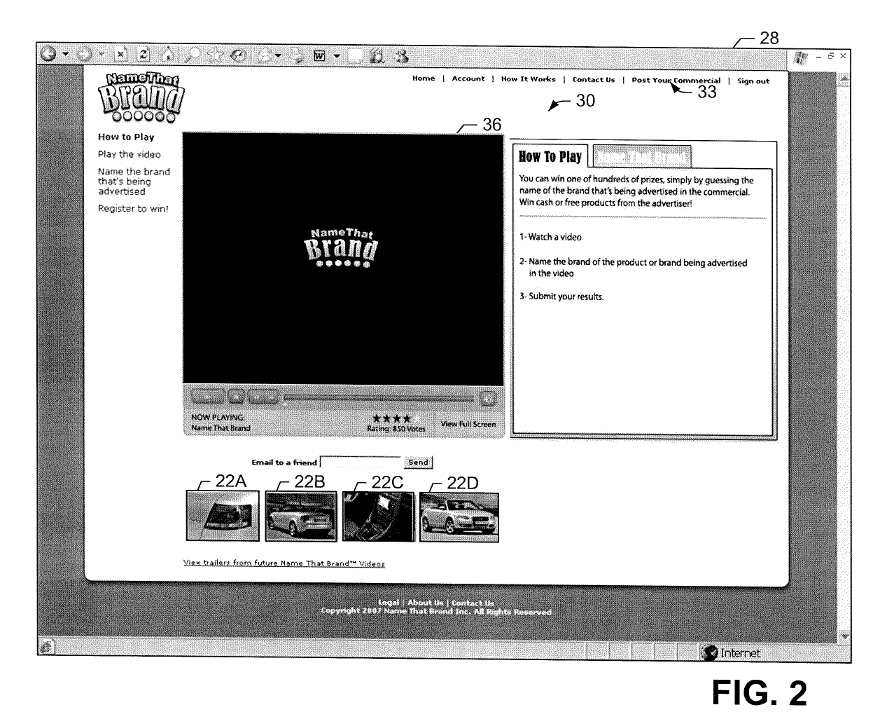

The server 12 hosts a website 28 that provides a game 30 in accordance with an example embodiment of the present invention. A screenshot of the website hosting the game 30 according to a typical commercial embodiment is shown in FIG. 2. As shown in FIG. 2, a plurality of videos 22A-D is available for viewing, and the user-selected video is displayed in a viewer 32. The viewer 32 can include controls for playing, stopping, fast-forwarding, rewinding, and pausing the video 22A. Additionally, the viewer can include volume controls. Also, as shown in FIG. 2, the website 28 includes a plurality of buttons or hotlinks for navigating to other pages on the website 28. One optional button is a button 33 for “Post Your Commercial.” Such button 33 would typically be clicked by an advertiser wishing to upload his video to the website 28.

The server 12 communicates with user devices 34A-N via a communications network 36. The communications network 36 preferably is a global computer network such as the Internet, and the system 10 preferably is implemented as an application service provided on the Internet. In a typical commercial embodiment, the server 12 is a bank of computer servers with a scalable architecture that is remotely located relative to the user devices 34A-N. The user devices 34A-N can be desktop computers, laptop computers, hand-held computers, PDA's, web-enabled phones, or other communication devices connected to the communications network 36. In alternative embodiments, the communications network 36 is provided by a wireless cellular network or another computer-based network.

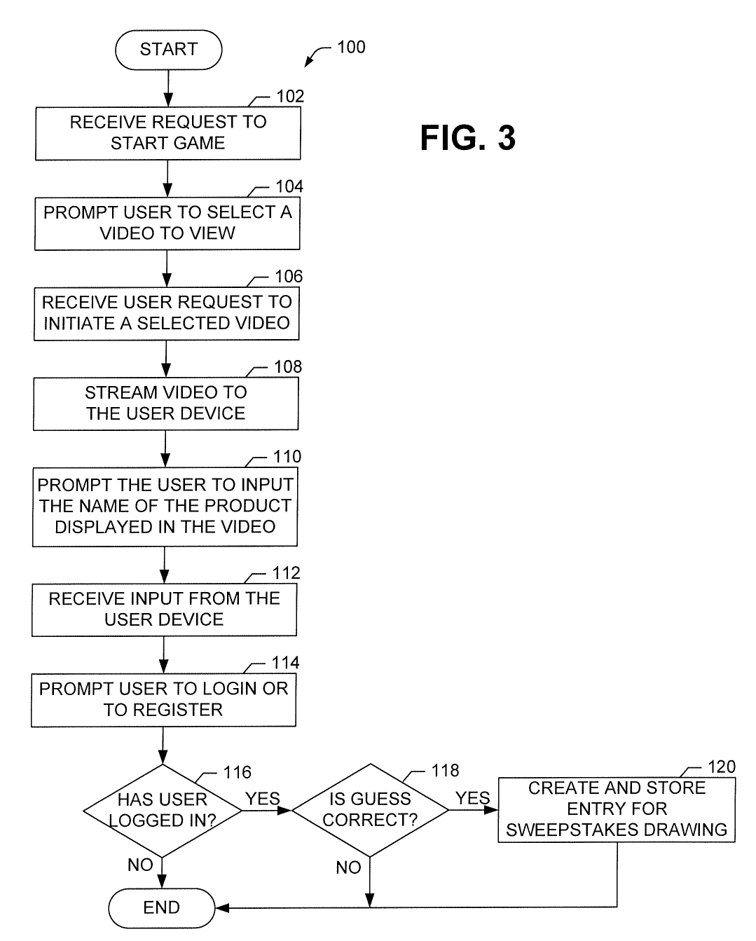

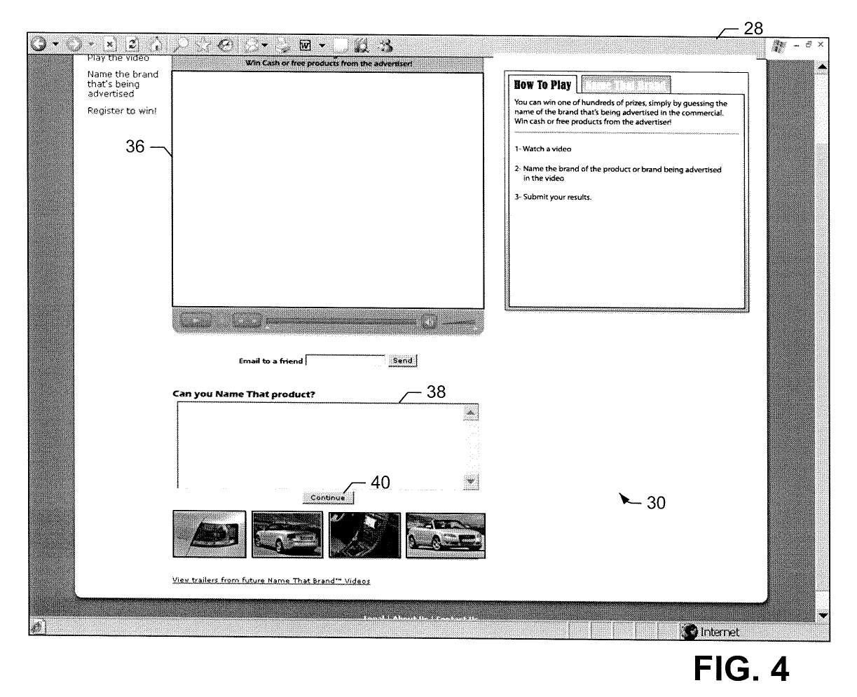

FIG. 3 depicts a flow diagram of a process 100 by which the server 12 of the system 10 provides the game 30 for marketing a product according to an example embodiment of the present invention. The process 100 can also be applied to marketing services. Beginning at step 102, the server 12 receives a request from a user, participant, or contestant wishing to play the game 30. Typically, the request is received via the website 28 for the game 30 when the user accesses the website. At step 104, the server 12 prompts the participant to select one of the plurality of videos 22A-D to view by displaying a message for a user to click on the video he wishes to view. At step 106, the server 12 receives the user's request for a selected video. At step 108, the server 12 streams the selected video 22A to the user device 34A via the viewer 32 in the website 28, as shown in a typical commercial embodiment depicted in FIG. 2. Once the video 22A finishes playing, the server 12 at step 110 sends a new page of the website to the user device 34A and prompts the user to enter a guess into a field 38 on the website 28, as shown in the typical commercial embodiment depicted in FIG. 4. Alternatively, the box in which the user can input a guess may be displayed adjacent the video, both during and after the video, along with a form for registering an account. Still alternatively, the box in which the user inputs a guess may displayed adjacent the video, and then once the user inputs a guess, a registration form appears.

The server 12 further prompts the user to click a “submit” or “continue” button 40 to submit his guess. Alternatively, the server 12 can provide a list of brand names from which the user can select and submit one, such as via buttons or drop-down menus. At step 112, the server 12 receives the user's guess as to the name brand of the product advertised in the video 22A. At step 114, the server 12 prompts the user to log in or to register an account if a user account had not been previously established. If at step 116 the server 12 determines that it has not received login information, then the process 100 ends. If however, at step 116 the server 12 determines that it has received login information, then the server 12 at step 118 determines if the user's guess is correct. If the server 12 determines at step 118 that the user's guess is incorrect, then the process 100 ends. If, however, the server 12 determines at step 118 that the user's guess is correct, then the server creates and stores an entry 26A for the user in the storage medium 20 at step 120. If a user account was not previously established, then the server 12 prompts the user to create an account prior to creating and storing the entry 26A in the storage medium 20. The process 100 ends. After the process 100 ends, the user can select another video to view, and hence initiate a new game. After step 120, the process 100 repeats for each game played. Preferably, a user is allowed one guess per video; however, in alternative embodiments, the user can select and play as many videos as many times as he chooses in order to increase his odds of winning a prize. Preferably, the server 12 does not charge users for playing the game 30. However, in alternative embodiments, the server 12 can charge the users a fee for playing the game 30. Those skilled in the art will understand that multiple users can each play a game at the same time other users are playing a game on the website.

In an alternative embodiment, the server 12 stores all user entries 26A though 26N, and not just entries that include the correct brand name, in the database 20. At a later date, the processor 14 of the server 12 can determine which entries include correct votes or guesses.

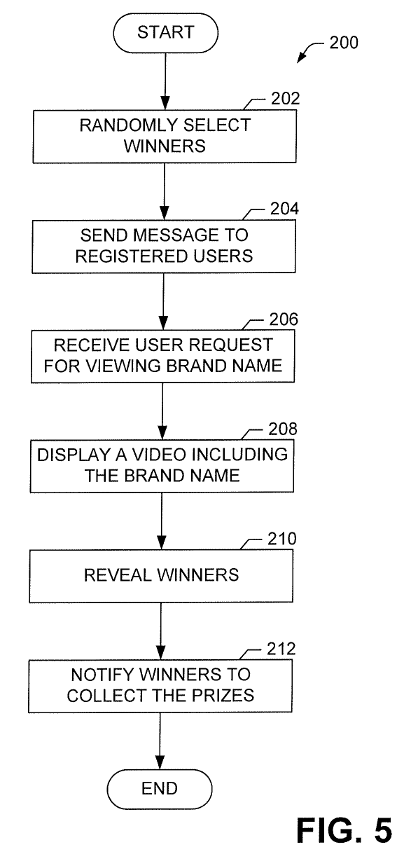

FIG. 5 depicts a flow diagram of a process 200 for providing the correct brand name of the product marketed through the process 100, according to an example embodiment of the present invention. Preferably, the server 12 does not notify the user as to whether or not his guess is correct at the time immediately following submission of the guess. Rather, in a typical commercial embodiment, the user is notified of the correct brand name at a later date and time, which may be predetermined. For example, the server 12 can be configured to reveal the brand name on a particular date at a particular time, such as noon EST on the last day of the month, 9:00 a.m. EST on the first Monday of the month, etc. However in alternative embodiments, the server 12 can display a message to the user immediately after receiving the user's guess stating whether or not his guess is correct.

Beginning at step 202, the processor 14 of the server 12 randomly selects one or more winners from the entries 26A-N stored in the storage medium 20. Preferably, the server 12 selects several winning entries 26A-N, and in a typical commercial embodiment, the server 12 selects twenty-five winning entries. However, those skilled in the art will understand that any number of winning entries is within the scope of the present invention. Preferably, the winning entries 26A-26N are selected from a group of entries that each includes the correct brand name. Alternatively, the winning entries 26A-26N can be selected from all entries, regardless of whether the participant submitted the correct brand name.

At step 204, the server 12 sends a message to each of the registered users notifying the registered users that the identity of the brand advertised in the initial video 22A will be revealed by clicking on an embedded hyperlink, which directs the user to a subsequent video. Preferably, the message is an email message, although those skilled in the art will understand that other messages, such as an SMS message, can be sent to the registered users as well. Additionally or alternatively, the website 28 can display a message stating that the brand name of the product advertised in the initial video 22A can be accessed by playing a subsequent video. At step 206, the server 12 receives the user request to access the subsequent video. Such request is typically received when the user clicks on the hyperlink embedded in the email message or on the website 28. Upon receiving the user request, the server 12 at step 208 displays a subsequent video that identifies the brand name to the user. After displaying the subsequent video, the server 12 at step 210 reveals whether or not the user is a winner. For example, the server 12 can display a message on the website 28 to the user that he is a winner or a message that he is not a winner. Additionally or alternatively, the server 12 can display on the website 28 a list of names of the winning users to all registered users. Alternatively, the winning users can be notified via email, via SMS message, or via another suitable notification technique.

At step 212, the server 12 notifies the winners to collect their prizes and how to collect their prizes. In a typical commercial embodiment, the prizes can be cash, gift certificates, products, or services. For example, the prizes can be $100 cash or a $100 gift certificate. Alternatively, the prizes can be one of the products or services being advertised. Those skilled in the art will understand any of a variety prizes having various values can be offered to the participants. However, in a typical commercial embodiment, the prizes are $100 cash. The server may prompt the winning user to submit his PAYPAL® account or other online account. After receiving the user's account number, the server 12 can cause funds to be transferred to the user's account. Alternatively, the server 12 can email the winning user a message containing a gift certificate with a code to be used at one or more online retailers. Still alternatively, the server 12 can prompt the winning user to submit a mailing address to which a check can be mailed. Those skilled in art will understand that there are various ways in which the server 12 can direct the prize to be delivered to the winning user.

Typically, once the brand name of the product is revealed in the subsequent video, the game for guessing the brand in that particular video is over. However, those skilled in the art will understand that it's possible that the video for the particular product whose brand name was revealed may be made available in the game 30 at a future date.

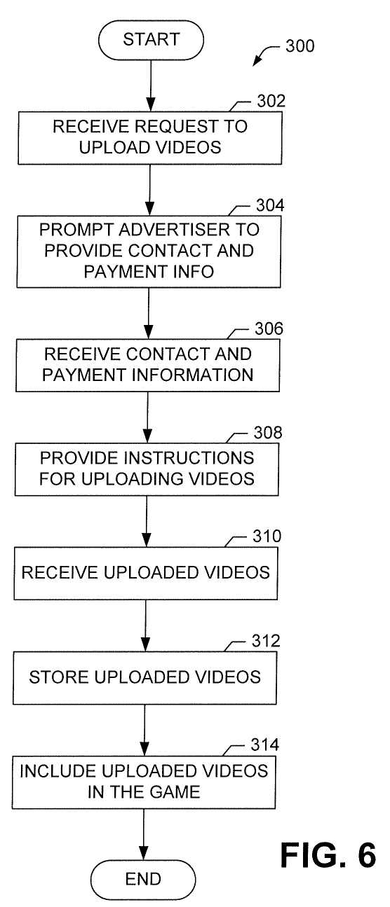

Optionally, the server 12 can solicit video commercials via its website 28. A process 300 for soliciting and receiving video commercials is depicted in the flow diagram of FIG. 6. Beginning at step 302, the server 12 receives a request for uploading videos to the game 30. In one embodiment, at least two videos are uploaded. The first video does not include the brand name of the product or service being advertised, whereas the second or subsequent video includes such information. Such request can be received when an advertiser clicks the “Post Your Commercial” button 33. Alternatively, only the first video without the brand name is uploaded, and the second video is uploaded at a later date, by the person who uploaded the first video, by an employee or agent of the person or company hosting the game, or by anyone else.

At optional step 304, the server 12 prompts the advertiser to provide contact information and payment information. In a typical commercial embodiment, the server 12 requests payment of a fee to upload the advertiser's video. However, those skilled in the art will understand that such service could alternatively be free. If requested, contact information can include the name of the company, address, billing address, contact person's information, etc. At step 306, the server 12 receives the contact and payment information.

At step 308, the server 12 provides instructions for uploading the video. For example, the server 12 can provide a step-by-step guide for guiding the uploading of the videos. The server 12 at step 310 receives the uploaded videos and stores the uploaded videos in the storage medium 20 at step 312. At step 314, the server 12 includes the videos in the game 30. For example, the first video, which does not include the brand name of the product or service being advertised, can be added to the list of videos from which the user can choose to display. The second video would typically be stored and available to be viewed at a later date.

In an alternative embodiment of the present invention, the server 12 can send a message, such as an email message, with an embedded link to the website 28. The user can then click on the link, view a video 22A preselected by the server 12, and then submit an entry, such as in the form of a guess or a vote, for the sweepstakes drawing. Still alternatively, the video 22A may be included in the email, and then after viewing the video, the user can then submit an entry for the sweepstakes drawing. Such entry can be submitted via email or another message, or such entry can be submitted by accessing the website 28.

In still another alternative embodiment, the first video 22 displayed may advertise a type of product or service, but not be directed to any particular brand, in an effort to entice companies to participate in the game. Thus, the first video may advertise a product or service that may apply to multiple brands. At some later date, the advertised item or service may be associated with a particular brand.

While the invention has been shown and described in preferred forms, it will be apparent to those skilled in the art that many modifications, additions, and deletions can be made therein. These and other changes can be made without departing from the spirit and scope of the invention as set forth in the following claims.

What is claimed is:

1. A computer-implemented game for marketing a product or service providing an associated brand name, comprising:
a computer hosting a website that is accessible by a network-connected user device, wherein the website provides a video of the product or service to be marketed without providing an associated brand name and prompts the user to enter a sweepstakes for a prize by submitting a guess as to the name of the product or service.

2. The computer-implemented game of claim 1, wherein the website provides a plurality of videos for viewing from which the user can select.

3. The computer-implemented game of claim 1, wherein the network is the Internet.

4. The computer-implemented game of claim 1, wherein the user device is one of a computer, cellular phone, or personal digital assistant.

5. The computer-implemented game of claim 1, wherein the computer is configured to send an email to the user when a subsequent video including the name of the product or service is available to be viewed.

6. The computer-implemented game of claim 5, wherein the computer is configured to notify the user if he won the prize after the user views the subsequent video.

7. A method of advertising an item or service, comprising:
displaying a video commercial to a participant, wherein the video does not include a name of the item or service that is being advertised;
prompting the participant to submit an entry as to the name of the item or service; and
if the participant provides a correct name, rewarding the participant with an award.

8. The method of claim 7, wherein the entry includes an inputted guess.

9. The method of claim 7, wherein the entry includes a vote.

10. The method of claim 7, wherein the step of displaying the video commercial includes streaming the video commercial to an Internet website.

11. The method of claim 7, further comprising receiving from the participant a selection of one of a plurality of video commercials to be displayed.

12. The method of claim 7, wherein the award is an entry in a drawing for a prize.

13. The method of claim 12, further comprising displaying the correct name of the item or service to the participant after the participant provides the guess.

14. The method of claim 13, wherein the step of displaying the correct name of the item or service occurs after the drawing for the prize.

15. The method of claim 14, wherein the displaying the correct name includes playing a subsequent video commercial including the name of the item or service being advertised.

16. The method of claim 15, further comprising sending the participant a message that includes a notification that the subsequent video is available for viewing.

17. The method of claim 7, further comprising randomly selecting an entry from the correct guesses as the winning entry.

18. The method of claim 17, further comprising notifying the participant associated with the winning entry of the prize won.

19. The method of claim 7, further comprising prompting a marketer to submit a video of an item or service to be advertised.

20. A system for marketing a branded product or service, comprising:
a plurality of user devices connected to a communications network; and
a server connected to the communications network, the server hosting a website that is accessible by the plurality of network-connected user devices, the website providing a game for guessing the brand being marketed, wherein the system receives a request from one of the user devices via the website for initiating the game, displays a selected video via the website, and receives a user input including a guess as to an identity of the brand.

21. The system of claim 20, wherein the plurality of network-connected user devices includes at least one or more of a computer, cellular phone, and personal digital assistant.

22. The system of claim 20, wherein the system further receives a selection of one video from a plurality of videos to be displayed.

23. The system of claim 20, wherein the system is configured to display the brand being marketed after receiving the user input.

24. The system of claim 20, wherein the system is configured to communicate with the winning user.
